(19) United States
(12) Patent Application Publication
(10) Pub. No.: US 2012/0318647 A1
(43) Pub. Date: Dec. 20, 2012

(54) MULTICONTACT UNIT COMPRISING AT LEAST TWO SEPARATE BLISTER-EFFECT ELECTRIC CONTACTS

(75) Inventor: Gilles Jurek, Plaisance-du-Touch (FR)

(73) Assignees: CONTINENTAL AUTOMOTIVE GMBH, Hannover (DE); CONTINENTAL AUTOMOTIVE FRANCE, Toulouse (FR)

(21) Appl. No.: 13/581,482

(22) PCT Filed: Mar. 23, 2011
(86) PCT No.: PCT/EP11/01436

§ 371 Date: Aug. 28, 2012

(30) Foreign Application Priority Data
Mar. 25, 2010 (FR) 1001191

(51) Int. Cl. H01H 9/00

(52) U.S. Cl. 200/16 C

(57) ABSTRACT

A multicontact block includes at least two independent electrical contacts (2-6) of the blister-effect type that are capable of elastic deformation. This multicontact block includes two longitudinal profile elements (11, 12), called stays, to each of which each blister-effect contact (2-6) is connected via an elastic flat section (21, 22) capable of allowing the elastic deformation of the contact, and two transverse profile elements for rigidification (7-10), called cross-ties, running between the stays (11, 12) and interposed between the contacts (2-6). Moreover, support lugs (13-16) are positioned under the profile elements (7, 10) and define a support reference plane for the multicontact block, designed to be intercepted by each contact (2-6) when it is deformed elastically.

The invention relates to a multicontact block comprising at least two independent electrical contacts of the blister-effect type, capable of elastic deformation between a rest position and a extreme active position.

The majority of manually-controlled electronic units, such as notably, in the field of automobiles, remotely-controlled electronic units equipping vehicle access systems, comprise control buttons designed to be manually actuated with a view to triggering a given action, whose functions are, on the one hand of an electrical nature, closing of an electronic circuit, and on the other hand of a mechanical nature, spring effect for returning to the rest position, touch-sensitive effect, endurance, etc.

One conventional and robust embodiment of these buttons consists in providing electrical activation by means of a switch soldered onto the printed circuit. However, this solution proves to be costly.

One less-costly solution consists in using conductive elastomers but the touch sensitivity turns out to be quite unsatisfactory owing to the sensation of “softness” provided by the button.

A third solution consists in using blister-effect elements which currently consist of separate metal contacts that are capable of elastic deformation between a rest position in which said contacts adopt a general concave domed shape, and a extreme active position in which these contacts undergo a deformation so as to exhibit a local inversion with respect to the initial dome shape.

However, the installation of these blister-effect contacts in an electronic housing proves to be problematic. This is because such contacts must be able to be freely deformed when they are activated and, for this reason, it is not possible to fix them directly onto printed circuits, for example by soldering. For this reason, these contacts are generally fixed under the mobile button, which can usually be carried out by adhesive bonding. However, this way of fixing by adhesive bonding turns out to be problematic because compliance with the qualification specifications (number of activations, climatic endurance, etc.) and maintaining a constant production quality imposes very strict conditions for the implementation of the adhesive bonding.

The present invention is also aimed at providing contacts of the blister-effect type, and its main objective is to provide contacts, on the one hand, whose cost of production is reduced with respect to that of the current contacts of this type, and on the other hand, whose installation within an electronic housing is facilitated and allows the qualification specifications to be satisfied with a high repeatability.

For this purpose, the subject of the invention is a multicontact block comprising at least two independent electrical contacts of the blister-effect type that are capable of elastic deformation. According to the invention, this multicontact block comprises:
two longitudinal profile elements, called stays, to each of which each blister-effect contact is connected via an elastic flat section capable of allowing the elastic deformation of said contact between its rest position and its extreme active position,
two transverse profile elements for rigidification, called cross-ties, running between the stays and interposed between the contacts,
and support lugs positioned under the profile elements and defining a support reference plane for the multicontact block, designed to be intercepted by each contact when it is deformed from its rest position toward its extreme active position.

Such a multicontact block therefore comprises, as a single piece, a rigid framework formed of stays and rigidification cross-ties, and a plurality of contacts connected to the stays of said framework via elastic means capable of allowing free deformation of said contacts.

In addition, this multicontact block comprises support lugs defining a reference plane and allowing said multicontact block to be rigidly installed correctly and quickly, for example by soldering onto a printed circuit, while guaranteeing a subsequent independent deformability of the various contacts, controlled by the presence of the cross-ties.

The design of the invention therefore leads to a notable financial gain relating to the cost of production of the contacts, owing notably to the formation of several contacts on one and the same part, and a notable gain in terms of assembly of the contacts, since a single operation, that may furthermore be repeatably automated, is required for the simultaneous installation of several contacts.

According to one advantageous embodiment aimed at optimizing the cost of production, the multicontact block according to the invention is formed from a metal plate opened up by cutting out the shapes notably by means of a tooling jig to be followed.

Moreover, according to this design, the support lugs advantageously consist of legs in the general form of angle pieces each obtained by cutting into a profile element and bending.

According to another advantageous embodiment of the invention aimed at guaranteeing a high longitudinal rigidity of the framework, each stay has a cross-section in the shape of an L formed from one wing section called horizontal section for joining to the contacts, and from another wing section called vertical section running above the plane defined by the horizontal sections.

In addition, in view of its transverse rigidity, the framework advantageously comprises at least two cross-ties under which the support lugs are furthermore advantageously positioned.

Thus, notably, when the multicontact block comprises at least three contacts, the latter advantageously comprises cross-ties interposed between each pair of contacts, which guarantee, aside from the transverse rigidity of the framework, that an identical flexibility is obtained for all the contacts, with the possible exception of the two contacts situated at the two longitudinal ends of the framework, which exhibit a slightly higher flexibility.

Furthermore, each contact advantageously has, from a plan view, the general shape of a rectangular tablet connected to the stays via elastic flat sections running from two opposing apices of said contact.

Moreover, each elastic flat section has the general shape of an S attached to a stay and to one of the apices of a contact so as to be aligned along the diagonal of said contact running between the two apices of the latter for connection with the stays.

This “symmetrical” positioning of the elastic flat sections allows the absence of “slippage” of the contacts to be guaranteed, which slippage is likely to cause wear of the conductive region of the integrated circuit on which the tablet comes into contact when it is deformed.

According to another advantageous embodiment of the invention, the multicontact block comprises longitudinal tabs protruding on the underside of the stays for centering of said block onto a support element such as a printed circuit.

These centering tabs are designed to be positioned in slots formed in the printed circuit before soldering, facilitating the positioning of the multicontact block.

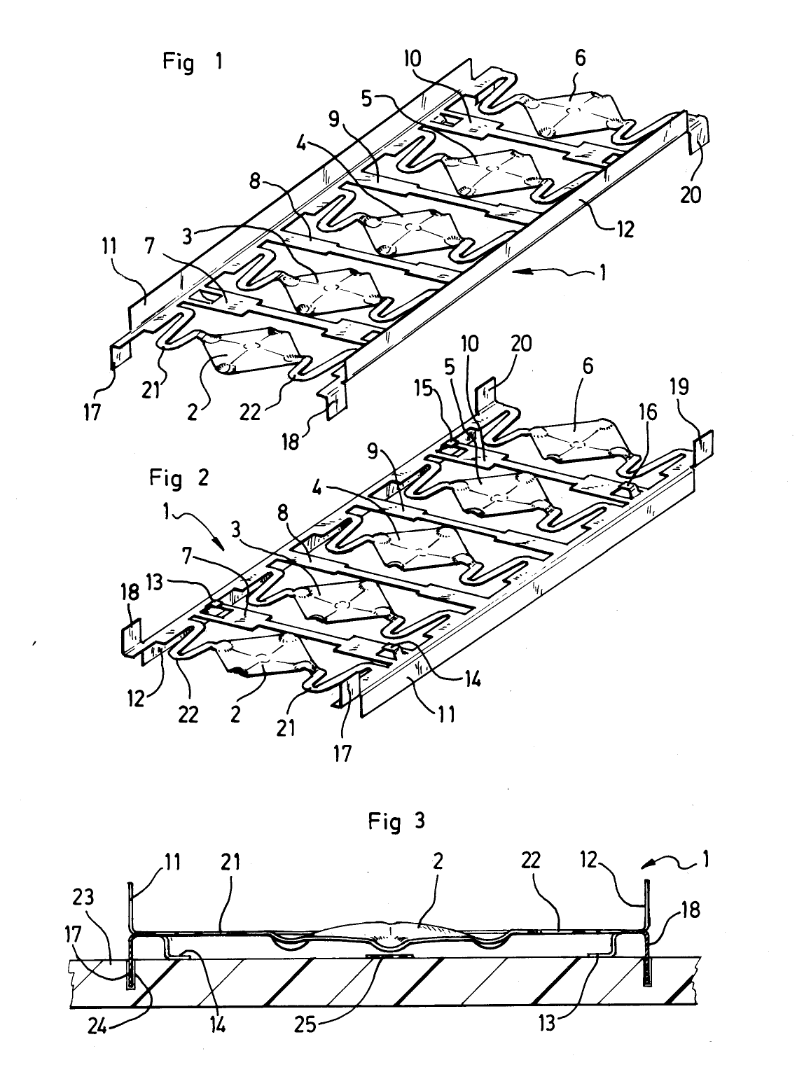

Other features, aims and advantages of the invention will become apparent from the detailed description that follows with reference to the appended drawings which show by way of non-limiting example one preferred embodiment of the invention. In these drawings:
FIG. 1 is a perspective view, seen from above, of a multicontact block according to the invention,
FIG. 2 is perspective view, seen from above, of this multicontact block,
and FIG. 3 is a transverse cross-section, on an enlarged scale, of this multicontact block positioned on a printed circuit.

The subject of the invention, shown by way of example in the figures, consists of a multicontact block comprising five independent electrical contacts 2-6 of the blister-effect type consisting of a tablet of generally rectangular shape configured so as to be capable of elastic deformation between a rest position, in which it has a general domed concave shape, and a extreme active position in which it is locally inverted with respect to its initial rest position.

This multicontact block, of generally rectangular shape, is advantageously formed by cutting out, by means of a tooling jig to be followed, of a plate made from an electrically-conductive material with a high modulus of elasticity, such as stainless steel 1.

This cutting out is designed to transform the initial plate 1 into a final block comprising, first of all, laterally, two longitudinal edges 11, 12 forming stays having an L-shaped cross-section formed from a wing section called horizontal section to which the contacts 2-6 are connected, and from a wing section called vertical section running above the plane defined by the horizontal wing sections.

The initial plate 1 is also formed in such a manner as to comprise four cross-ties 7-10 running between the horizontal wing sections of the stays 11, 12, in the same plane as said horizontal wing sections, said cross-ties being each interposed between two contacts 2-3, 3-4, 4-5 and 5-6, equidistant from each of the two contacts.

In addition, two of these cross-ties, in the example the two end cross-ties 7 and 10, in other words each of the cross-ties closest to one of the longitudinal ends of the block has, at each of their longitudinal ends, a cutout defining, after bending, a support lug consisting of a leg in the general shape of an angle piece, respectively legs 13-14 for the cross-ties 7 and legs 15-16 for the cross-tie 10, all of said support lugs defining a support reference plane for the multicontact block.

Furthermore, the multicontact block also comprises longitudinal tabs 17-20, protruding on the underside of the stays 11, 12, for centering said block on a printed circuit. In the example, these tabs 17-20 number four and are each disposed on the underside of the horizontal section of the stays 11, 12, at each of the ends of each of said stays.

As is shown in FIG. 3, such tabs 17-20 are designed to be accommodated in slots such as 24 formed in a printed circuit 23, in a position of the multicontact block in which the latter rests by means of the support lugs 13-16 on said printed circuit.

Lastly, each of the five contacts 2-6 is positioned midway between the two stays 11, 12, and the rectangular tablet forming each of said contacts is connected to said stays via elastic flat sections 21, 22 running from two opposing apices of said tablet.

In addition, each of the elastic flat sections 21, 22 has the general shape of an S attached to the horizontal section of a stay 11, 12 and to one of the apices of a contact 2-6, so as to be aligned along the diagonal of said contact running between the two apices of the latter for connection with the stays.

Such elastic flat sections 21, 22 are designed in such a manner that, when the multicontact block rests on a printed circuit 23 via its support lugs 13-16, each contact 2-6 has an active position in which said contact is in contact with an electrically-conductive region 25 of a printed circuit 23.

Such a multicontact block therefore comprises, as a single piece, a plurality of contacts 2-6 connected to a framework 7-12 by means of elastic means 21, 22 capable of allowing an independent free deformation of said contacts.

In addition, this multicontact block comprises support lugs 13-16 defining a reference allowing said multicontact block to be rigidly installed correctly and quickly, for example by soldering, onto a printed circuit 23, while guaranteeing the subsequent individual deformability of each of the contacts 2-6.

1. A multicontact block comprising at least two independent electrical contacts (2-6) of the blister-effect type that are capable of elastic deformation between a rest position and an extreme active position, characterized in that the multicontact block comprises:
two longitudinal profile elements (11, 12), called stays, to each of which each blister-effect contact (2-6) is connected via an elastic flat section (21, 22) capable of allowing the elastic deformation of said contact between its rest position and its extreme active position,
two transverse profile elements for rigidification (7-10), called cross-ties, running between the stays (11, 12) and interposed between the contacts (2-6),
and support lugs (13-16) positioned under the profile elements (7, 10) and defining a support reference plane for the multicontact block, designed to be intercepted by each contact (2-6) when it is deformed from its rest position toward its extreme active position.

2. The multicontact block as claimed in claim 1 characterized in that it is formed from a metal plate (1) opened up by cutting out the shapes notably by means of a tooling jig to be followed.

3. The multicontact block as claimed in claim 2 characterized in that the support lugs consist of legs (13-16) in the general form of angle pieces each obtained by cutting into a profile element (7, 10) and bending.

4. The multicontact block as claimed in claim 1 characterized in that each stay (11, 12) has a cross-section in the shape of an L formed from one wing section called horizontal section for joining to the contacts (2-6), and from another wing section called vertical section running above the plane defined by the horizontal sections.

5. The multicontact block as claimed in claim 1 characterized in that it comprises at least two cross-ties (7-10) under which the support lugs (13-16) are positioned.

6. The multicontact block as claimed in claim 5 characterized in that it comprises at least three contacts (2-6) and cross-ties (7-10) interposed between each pair of contacts.

7. The multicontact block as claimed in claim 1 characterized in that each contact (2-6) has, from a plan view, the general shape of a rectangular tablet connected to the stays (11, 12) by elastic flat sections (21, 22) running from two opposing apices of said contact.

8. The multicontact block as claimed in claim 7 characterized in that each elastic flat section (21, 22) has the general shape of an S attached to a stay (11, 12) and to one of the apices of a contact (2-6) so as to be aligned along the diagonal of said contact running between the two apices of the latter for connection with the stays.

9. The multicontact block as claimed in claim 1 characterized in that it comprises longitudinal tabs (17-20) protruding on the underside of the stays (11, 12) for centering of said block onto a support element (23) such as a printed circuit.

10. The multicontact block as claimed in claim 2 characterized in that each stay (11, 12) has a cross-section in the shape of an L formed from one wing section called horizontal section for joining to the contacts (2-6), and from another wing section called vertical section running above the plane defined by the horizontal sections.

11. The multicontact block as claimed in claim 3 characterized in that each stay (11, 12) has a cross-section in the shape of an L formed from one wing section called horizontal section for joining to the contacts (2-6), and from another wing section called vertical section running above the plane defined by the horizontal sections.

12. The multicontact block as claimed in claim 2 characterized in that it comprises at least two cross-ties (7-10) under which the support lugs (13-16) are positioned.

13. The multicontact block as claimed in claim 3 characterized in that it comprises at least two cross-ties (7-10) under which the support lugs (13-16) are positioned.
